(19) United States
(12) Patent Application Publication
(10) Pub. No.: US 2007/0205605 A1
(43) Pub. Date: Sep. 6, 2007

(54) BOLT ASSEMBLY FOR LOCK

(75) Inventor: Chung-Liang Lin, Annan (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: I-TEK METAL MFG. CO., LTD., Annan (TW)

(21) Appl. No.: 11/307,996

(22) Filed: Mar. 2, 2006

(51) Int. Cl. E05C 21/00

(52) U.S. Cl. 292/1

(57) ABSTRACT

A bolt assembly includes a bolt head, a draw bar, and a pin. The bolt head includes a latching portion and an attachment portion. The attachment portion includes an axial bore and a pin hole extending in a direction transverse to the axial bore and intersecting the axial bore. The draw bar includes a front end mounted in the axial bore of the attachment portion. The front end of the draw bar includes a notch that is aligned with the pin hole. The pin is mounted in the pin hole of the attachment portion and the notch of the draw bar, thereby securing the bolt head and the draw bar together.

### BACKGROUND OF THE INVENTION

1. Field of the Invention

The present invention relates to a bolt assembly. More particularly, the present invention relates to a bolt assembly for a door lock.

2. Description of the Related Art

A door lock typically comprises a latch bolt and a dead bolt, wherein the latch bolt can be retracted by turning either handle. U.S. Pat. No. 5,697,563 discloses a bolt assembly comprising a bolt body, a draw bar, and a spring pin. The bolt body has a tapered latching end and an attachment end. The attachment end has a cylindrical axial bore and a transverse drilled hole, of a small diameter compared to the axial bore, intersecting the axial bore such that the outer edge of the drilled hole is substantially tangent to the axial bore. The draw bar has a diameter which makes a snug fit in the axial bore when inserted therein and which is circumscribed by a groove. The groove is of a depth and width equal to the diameter of the drilled hole. The spring pin is pressed into the drilled hole and the groove to secure the draw bar to the bolt body.

Although it is not necessary to particularly align the axial bore with the annular groove of the draw bar during assembly of the spring pin, the annular groove adversely affects the strength of the draw bar. Namely, the draw bar is liable to break.

### BRIEF SUMMARY OF THE INVENTION

An objective of the present invention is to provide a bolt assembly for a lock with improved strength while allowing easy assembly.

A bolt assembly in accordance with the present invention comprises a bolt head, a draw bar, and a pin. The bolt head comprises a latching portion and an attachment portion. The attachment portion comprises an axial bore and a pin hole extending in a direction transverse to the axial bore and intersecting the axial bore. The draw bar comprises a front end mounted in the axial bore of the attachment portion. The front end of the draw bar comprises a notch that is aligned with the pin hole. The pin is mounted in the pin hole of the attachment portion and the notch of the draw bar, thereby securing the bolt head and the draw bar together.

Preferably, the attachment portion of the bolt head comprises an outer end face, and the axial bore extends inward from the outer end face into the attachment portion.

Preferably, the attachment portion of the bolt head comprises a top face and a bottom face, and the pin hole extends from the top face through the bottom face of the attachment portion.

Preferably, the pin hole intersects the axial bore by a half of the pin hole.

Preferably, a distance from the notch to a front end face of the draw bar is equal to that from the pin hole to an inner end wall delimiting the axial bore of the attachment portion.

Preferably, the notch is defined in a portion of a circumference of the front end of the draw bar.

Preferably, the notch has a width the same as a diameter of the pin hole and a depth the same as a radius of the pin hole.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a bolt assembly for a lock in accordance with the present invention and a portion of a door to which the lock is mounted.

FIG. 2 is an exploded perspective view of the bolt assembly in accordance with the present invention.

FIG. 3 is a sectional view of the door in FIG. 1.

FIG. 4 is a sectional view taken along plane 4-4 in FIG. 3.

### DETAILED DESCRIPTION OF THE INVENTION

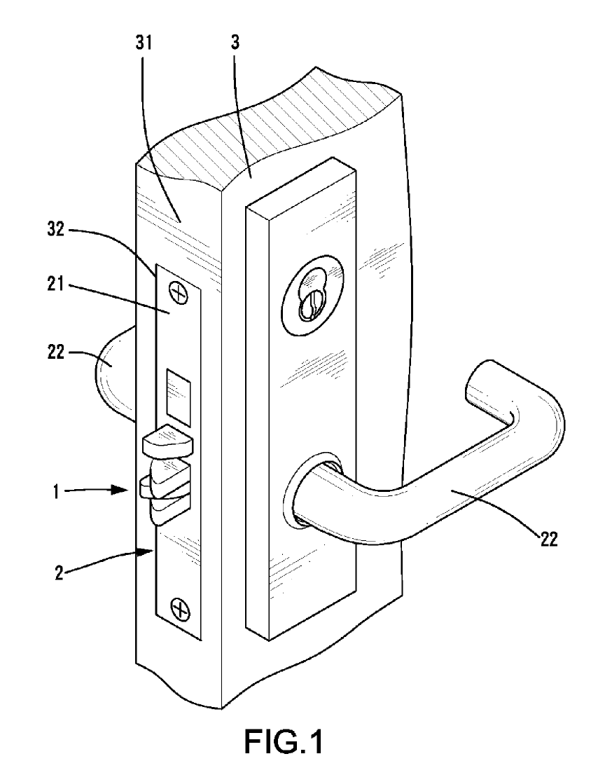

FIG. 1 illustrates a lock 2 mounted to a door 3 and including a bolt assembly 1 in accordance with the present invention. The lock 2 comprises a lock case 21 mounted in a compartment 32 in an edge 31 of the door 3 and inner and outer handles 22. The bolt assembly 1 is mounted in the lock case 21 and moveable between an extended position (see FIG. 1) and a retracted position under operation of either handle 22.

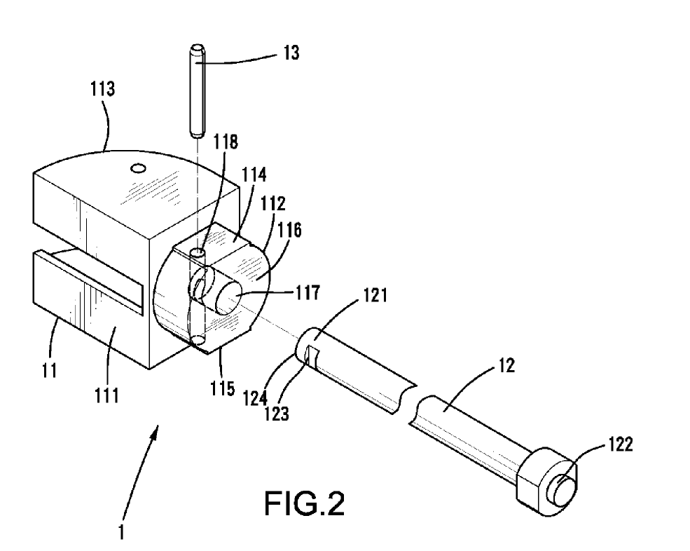

Referring to FIG. 2, the bolt assembly 1 in accordance with the present invention comprises a bolt head 11, a draw bar 12, and a pin 13. The bolt head 11 comprises a latching portion 111 that extends out of the case 21 when in the extended position. The bolt head 11 further comprises an attachment portion 112 extending from a rear of the latching end 111. The latching portion 111 is generally tapered (see tapering 113).

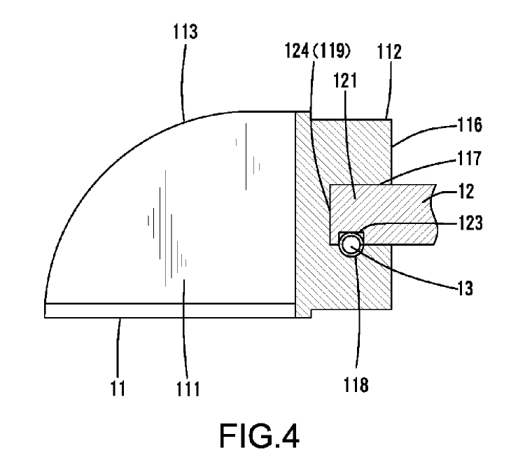

Referring to FIGS. 2 through 4, the attachment portion 112 includes an top face 114, a bottom face 115, and an outer end face 116. These faces 114, 115, and 116 are substantially planar in this example. An axial bore 117 extends inward into the attachment portion 112 from the outer end face 116 to a depth. Referring to FIG. 4, the depth of the axial bore 117 is preferably greater than a half of an axial length of the attachment portion 112. The attachment portion 112 further comprises a pin hole 118 extending in a direction transverse to the axial bore 117. In this example, the pin hole 118 extends from the top face 114 through the bottom face 115. Preferably, the pin hole 118 intersects the axial bore 117 by a half of the pin hole 118.

The draw bar 12 is substantially cylindrical and comprises a front end 121 to be inserted into the axial bore 117 and a rear end 122 to which a spring (not shown) or the like is engaged. A notch 123 is defined in a portion of a circumference of the front end 121. Preferably, a distance from the notch 123 to a front end face 124 of the draw bar 12 is the same as that from the pin hole 118 to an inner end wall 119 delimiting the axial bore 117 such that the notch 123 is aligned (with or without adjustment) with the pin hole 118 when the draw bar 12 comes in contact with the inner end wall 119 delimiting the axial bore 117. Preferably, the notch 123 has a width the same as a diameter of the pin hole 118 and a depth the same as a radius of the pin hole 118, as shown in FIG. 4.

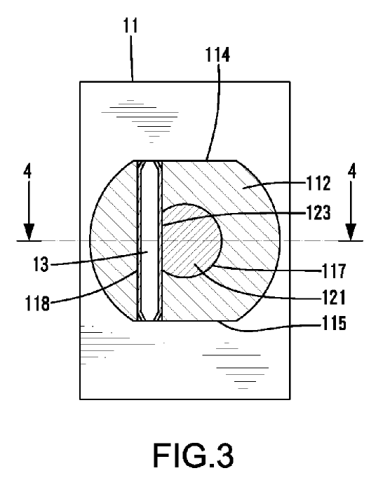

The pin 13 has a diameter allowing it to be tightly engaged in the pin hole 118. Preferably, the pin 13 has a length the same as that of the pin hole 118. Referring to FIGS. 3 and 4, when the front end 121 of the draw bar 12 is inserted into the axial bore 117 of the attachment portion 112 of the bolt body 11, with the notch 123 of the draw bar 12 slightly aligned with the pin hole 118, the pin 13 can be then inserted into the pin hole 118 and through the notch 123, thereby securing the draw bar 12 and the bolt body 11 together.

In assembly, the front end 121 of the draw bar 12 is inserted into the axial bore 117 until the front end face 124 of the draw bar 12 comes in contact with the inner end wall 119 delimiting the axial bore 117, with the notch 123 aligned with the pin hole 118. Then, the pin 13 is inserted into the pin hole 118, with a half of the pin 13 engaged in the notch 123. In a case that the notch 123 of the draw bar 12 is not completely aligned with the pin hole 118, the draw bar 12 will be turned to the completely aligned position by the pin 13 passing through the notch 123. Thus, the draw bar 12 and the bolt body 11 can be rapidly and easily secured together. It is noted that the notch 123 can be formed by milling a small portion of the circumference of the front end 121 of the draw bar 12 without largely sacrificing the structural strength of the draw bar 12.

Although specific embodiments have been illustrated and described, numerous modifications and variations are still possible without departing from the essence of the invention. The scope of the invention is limited by the accompanying claims.

What is claimed is:

1. A bolt assembly comprising:
a bolt head comprising a latching portion and an attachment portion, the attachment portion comprising an axial bore and a pin hole extending in a direction transverse to the axial bore and intersecting the axial bore;
a draw bar comprising a front end mounted in the axial bore of the attachment portion, the front end of the draw bar comprising a notch that is aligned with the pin hole; and
a pin mounted in the pin hole of the attachment portion and the notch of the draw bar, thereby securing the bolt head and the draw bar together.

2. The bolt assembly as claimed in claim 1 wherein the attachment portion of the bolt head comprises an outer end face, and wherein the axial bore extends inward from the outer end face into the attachment portion.

3. The bolt assembly as claimed in claim 1 wherein the attachment portion of the bolt head comprises a top face and a bottom face, and wherein the pin hole extends from the top face through the bottom face of the attachment portion.

4. The bolt assembly as claimed in claim 3 wherein the pin hole intersects the axial bore by a half of the pin hole.

5. The bolt assembly as claimed in claim 1 wherein a distance from the notch to a front end face of the draw bar is equal to that from the pin hole to an inner end wall delimiting the axial bore of the attachment portion.

6. The bolt assembly as claimed in claim 1 wherein the notch is defined in a portion of a circumference of the front end of the draw bar.

7. The bolt assembly as claimed in claim 1 wherein the notch has a width the same as a diameter of the pin hole and a depth the same as a radius of the pin hole.
